(19) United States
(12) Patent Application Publication
(10) Pub. No.: US 2019/0184792 A1
(43) Pub. Date: Jun. 20, 2019

(54) AROMA GENERATING DEVICE FOR VEHICLE

(71) Applicant: TOYOTA JIDOSHA KABUSHIKI KAISHA, Toyota-shi (JP)

(72) Inventor: Tomohiro WATANABE, Toyota-shi (JP)

(73) Assignee: TOYOTA JIDOSHA KABUSHIKI KAISHA, Toyota-shi (JP)

(21) Appl. No.: 16/184,261

(22) Filed: Nov. 8, 2018

(30) Foreign Application Priority Data
Dec. 19, 2017 (JP) 2017-243028

(51) Int. Cl. B60H 3/00

(52) U.S. Cl. CPC B60H 3/0035

(57) ABSTRACT

An aroma generating device for a vehicle includes: a door opening detecting section configured to detect whether or not a door of a vehicle has been opened; an aroma generating section configured to release aromatic components within a vehicle cabin at a time of operation, the aromatic components are filled within a container; and an aroma control section configured to control the aroma generating section to start operation in a case in which the door opening detecting section detects that a door has been opened, and to stop operation in a case in which a predetermined time period has elapsed from the start of operation of the aroma generating section.

### CROSS-REFERENCE TO RELATED APPLICATION

This application claims priority under 35 USC 119 from Japanese Patent Application No. 2017-243028, filed on Dec. 19, 2017, the disclosure of which is incorporated by reference herein.

### BACKGROUND

### Technical Field

The present disclosure relates to an aroma generating device for a vehicle.

### Related Art

Blowing a pleasing aroma into the vehicle interior so as to improve the mood of the vehicle occupants or so as to make it difficult to smell (so as to mask) disagreeable odors within the vehicle is carried out. Conventionally, aromas have been dispersed within a vehicle by using commercially available aromatic agents, but, with commercially-available aromatic agents, it takes time for the aroma to be sufficiently dispersed within the vehicle.

Japanese Patent Application Laid-Open (JP-A) No. 2004-268704 discloses an invention relating to an aroma generating device for a vehicle that includes blowing means for generating a flow of air that carries an aroma generated by an aroma generator.

However, the aroma generating device for a vehicle that is disclosed in JP-A No. 2004-268704 presupposes operation when it is necessary to calm the vehicle occupants such as in a case in which a vehicle occupant does not feel well or in a case in which an accident occurs or the like, and control of the generation of an aroma, which takes into consideration the timing at which a vehicle occupant enters into the vehicle, is not carried out.

### SUMMARY

The present disclosure provides an aroma generating device for a vehicle that may control of the generation of an aroma by taking into consideration the timing at which a vehicle occupant enters into a vehicle.

A first aspect of the present disclosure is an aroma generating device for a vehicle, including: a door opening detecting section configured to detect whether or not a door of a vehicle has been opened; an aroma generating section configured to release aromatic components within a vehicle cabin at a time of operation, the aromatic components are filled within a container; and an aroma control section configured to control the aroma generating section to start operation in a case in which the door opening detecting section detects that a door has been opened, and to stop operation in a case in which a predetermined time period has elapsed from the start of operation of the aroma generating section.

In accordance with the aroma generating device for a vehicle of the first aspect, when it is detected that a door has been opened, aromatic components may be released into the vehicle cabin for a predetermined time period.

In a second aspect of the present disclosure, in the above-described aspect, the aroma control section may be configured to control the start of the operation of the aroma generating section in a case in which the door opening detecting section detects that a door has been opened a first time after a change in date.

In accordance with the aroma generating device for a vehicle of the second aspect, aromatic components may be released into the vehicle cabin when it is detected that a door has been opened for a first time after a change in the date.

In a third aspect of the present disclosure, in the above-described aspect, the predetermined time period may be from the start of operation of the aroma generating section until an intensity of aromatic components that a vehicle occupant smells within the vehicle cabin becomes an upper limit value.

In accordance with the aroma generating device for a vehicle of the third aspect, the aroma generating section is operated until the intensity of the aromatic components that the vehicle occupant smells within the vehicle cabin becomes the upper limit value thereof.

In a fourth aspect of the present disclosure, in the above-described aspect, the door opening detecting section may detect whether or not a driver's seat door has been opened.

In accordance with the aroma generating device for a vehicle of the fourth aspect, the aroma generating section is operated by being triggered by the opening of the driver's seat door.

In accordance with the aroma generating device for a vehicle of the first aspect, control of the generation of an aroma, which takes into consideration the timing of a vehicle occupant entering the vehicle, may be possible.

In accordance with the aroma generating device for a vehicle of the second aspect, the aroma generating section is operated in a case in which it is detected that a door of the vehicle has been opened a first time after a change in the date. Due thereto, driving after waking or the first drive of the day may be started pleasantly.

In accordance with the aroma generating device for a vehicle of the third aspect, the aroma generating section is operated until the intensity of the aromatic components that the vehicle occupant smells within the vehicle cabin becomes the upper limit value. Due thereto, the aromatic components may be dispersed effectively within the vehicle cabin without being released wastefully.

In accordance with the aroma generating device for a vehicle of the fourth aspect, the aroma generating section is operated by being triggered by the opening of the driver's seat door. Due thereto, the aroma generating section may be operated on the assumption that driving has started.

### BRIEF DESCRIPTION OF THE DRAWINGS

Exemplary embodiments will be described in detail based on the following figures, wherein:

FIG. 1 is a block drawing showing the structure of an aroma generating device for a vehicle relating to an exemplary embodiment of the present disclosure;

FIG. 2A is a schematic drawing showing a case in which a cartridge that is used at a time of heating is selected at the aroma generating device relating to the exemplary embodiment of the present disclosure;

FIG. 2B is a schematic drawing showing a case in which a cartridge to be used is selected at the aroma generating device relating to the exemplary embodiment of the present disclosure;

FIG. 2C is a schematic drawing showing a case in which aromatic components are not released at the aroma generating device relating to the exemplary embodiment of the present disclosure;

FIG. 3 is a schematic drawing showing another example of the aroma generating device relating to the exemplary embodiment of the present disclosure;

FIG. 4 is a time chart showing the state of operation over time of the aroma generating device for a vehicle relating to the exemplary embodiment of the present disclosure; and

FIG. 5 is a flowchart showing aroma generating processing of the aroma generating device for a vehicle relating to the exemplary embodiment of the present disclosure.

### DETAILED DESCRIPTION

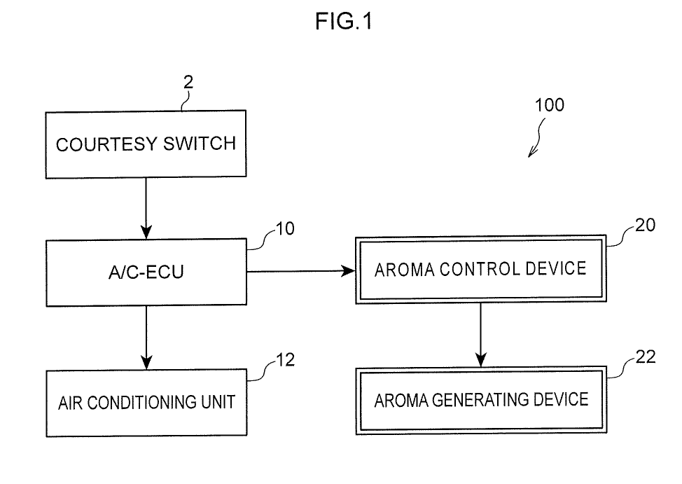

An aroma generating device 100 for a vehicle relating to the present exemplary embodiment is described hereinafter by using FIG. 1 through FIG. 5. FIG. 1 is a block drawing showing an example of the structure of the aroma generating device 100 for a vehicle relating to the present exemplary embodiment. The aroma generating device 100 for a vehicle that is shown in FIG. 1 operates in cooperation with the air conditioning of the vehicle. A signal instructing the vehicle cabin temperature from a temperature setting section (not illustrated) provided at the instrument panel of the vehicle, information such as the temperature of the blown air at the blowing port of an air conditioning unit 12 from dedicated sensors (not illustrated) or the like, and signals relating to turning the air conditioning unit 12 ON and OFF by the switch operation of a vehicle occupant, are respectively inputted to an air conditioning ECU (Electronic Control Unit) 10 that controls the air conditioning unit 12.

Moreover, signals from a courtesy switch 2 are inputted to the air conditioning ECU (hereinafter abbreviated as “A/C-ECU”) 10. The courtesy switch 2 is a switch that detects the opening/closing of the respective doors of the vehicle. As an example, a sensor that outputs an electric signal when pressure is applied thereto, such as a piezoelectric element or the like, is used as the courtesy switch 2. In the present exemplary embodiment, on the basis of the signal outputted from the courtesy switch 2, the A/C-ECU 10 detects that the driver's seat door has been opened or closed, and in particular, that this door has been opened.

The A/C-ECU 10 controls the air conditioning unit 12 on the basis of inputted signals and information. The signals relating to this control are also inputted to an aroma control device 20, and the aroma control device 20 controls an aroma generating device 22 in accordance with these signals. The A/C-ECU 10 outputs a signal for operating the aroma generating device 22 to the aroma control device 20 also in cases in which it is detected that the driver's seat door has been opened or closed.

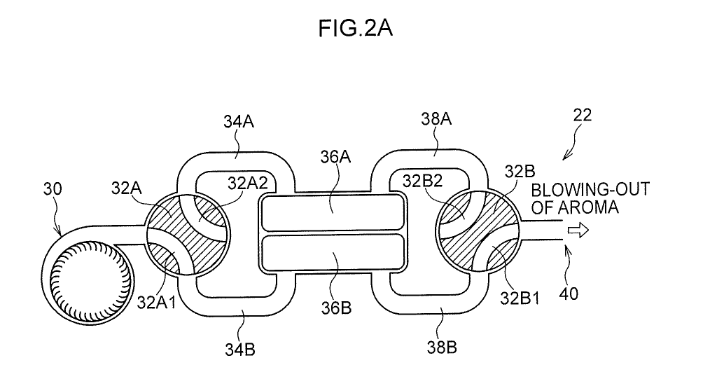

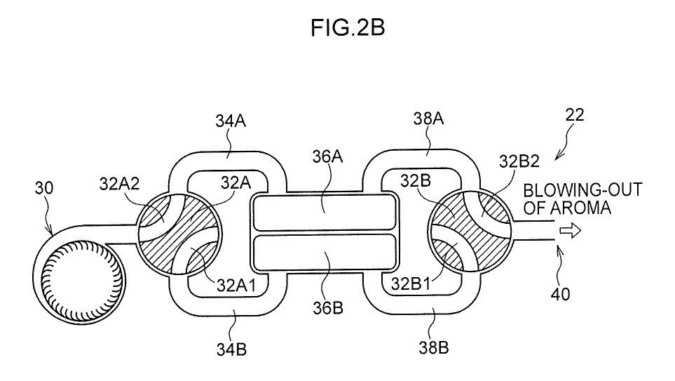

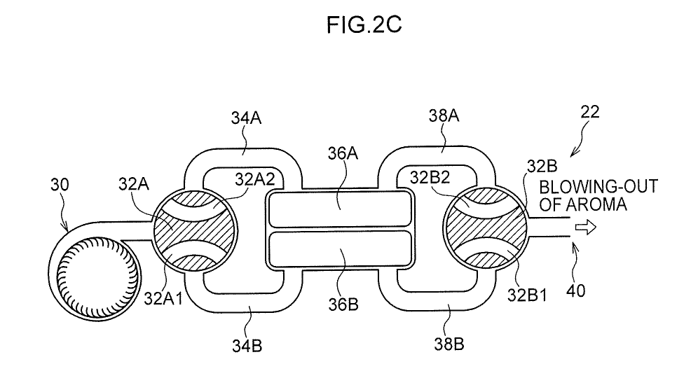

FIG. 2 is a schematic drawing showing an example of the aroma generating device 22 relating to the present exemplary embodiment. The aroma generating device 22 shown in FIG. 2 has cartridges that are a cartridge 36A and a cartridge 36B that are filled with different perfumes, and, in accordance with the situation, selects the cartridge that is to be used. For example, the cartridge 36A is filled with a perfume that is minty and has a refreshing feeling, or the like, and cartridge 36B is filled with a perfume that is vanilla-based and gives-off a sweet and warm impression, or the like. At the time of cooling, the cartridge 36A is used, and, at the time of heating, the cartridge 36B is used. Further, other than a minty and a vanilla-based perfume, for example, a citrusy perfume may be filled in a cartridge.

The cartridges 36A, 36B are structures in which, for example, such perfumes are filled into carriers that are chemically inactive and that are porous and that are suitable for adsorbing the perfumes. For example, any of silica gel, alumina, diatomaceous earth, or the like is used as the carriers.

FIG. 2A is a schematic drawing showing a case in which the cartridge 36B of the aroma generating device 22 relating to the present exemplary embodiment is selected. The aroma generating device 22 relating to the present exemplary embodiment sends blown air from a blower 30, which is structured by a multiblade fan such as a sirocco fan or the like that is rotated by an electric motor, via a door 32A, which is a type of valve that is operated by an actuator such as a stepping motor or the like, to the cartridge 36A or the cartridge 36B via an air blowing path 34A or an air blowing path 34B. The aroma generating device 22 may be provided with a heating device that heats the cartridges 36A, 36B by electric heating, and, by using this heating device, the aroma generating device 22 can emit the perfume, which has been adsorbed by the carrier, more effectively than if the perfume is at an ordinary temperature. However, because components that are weak with respect to heat also exist in the perfume, in this case, there is no need for a heating device that carries out heating by electric heating.

FIG. 2A illustrates a case in which the perfume that is filled in the cartridge 36B is released. Therefore, the door 32A rotates and stops so as to connect the blower 30 and the air blowing path 34B by an air blowing channel 32A1. Further, in conjunction with the door 32A, a door 32B rotates and stops by the power of an actuator such as a stepping motor or the like, so as to connect an air blowing path 38B and an air blowing port 40 by an air blowing channel 32B1.

As a result, the blown air from the blower 30 reaches the cartridge 36B via the air blowing channel 32A1 of the door and the air blowing path 34B, and emits the perfume that is filled in the cartridge 36B. The perfume that is released from the cartridge 36B is, together with the blown air from the blower 30, released, via the air blowing path 38B and the air blowing channel 32B1, into the vehicle interior from the air blowing port 40 and together with the blown air of the air conditioning unit 12, and the blown air of the air conditioning unit 12 is scented.

FIG. 2B is a schematic drawing showing a case in which the perfume that is filled in the cartridge 36A is released. The door 32A rotates and stops so as to connect the blower 30 and the air blowing path 34A by an air blowing channel 32A2. Further, in conjunction with the door 32A, the door 32B rotates and stops so as to connect an air blowing path 38A and the air blowing port 40 by an air blowing channel 32B2.

As a result, the blown air from the blower 30 reaches the cartridge 36A via the air blowing channel 32A2 of the door 32A and the air blowing path 34A, and emits the perfume that is filled in the cartridge 36A. The perfume that is released from the cartridge 36A is, together with the blown air from the blower 30, released, via the air blowing path 38A and the air blowing channel 32B2, into the vehicle interior from the air blowing port 40 and together with the blown air of the air conditioning unit 12.

In FIG. 2A and FIG. 2B, the air blowing channels 32A1, A2 are connected without offset to the blower 30 and the air blowing paths 34A, 34B, and the air blowing channels 32B1, B2 are connected without offset to the air blowing paths 38A, 38B and the air blowing port 40. However, by offsetting these connections, the blowing of air to the cartridges 36A, 36B can be controlled. As an example, by slightly offsetting the connections between the air blower 30 and the air blowing channel 32A1 and the air blowing path 34B, the sectional surface areas of the connected section are reduced, and the blowing of air from the blower 30 to the cartridge 36B can be curbed. As a result, the strength of the scenting of the blown air may be controlled.

FIG. 2C is a schematic drawing showing a case in which aromatic components are not released at the aroma generating device 22 relating to the present exemplary embodiment. As shown in FIG. 2C, the air blowing channels 32A1, 32A2 of the door 32A are not connected to the air blower 30 and the air blowing paths 34A, 34B. Further, the air blowing channels 32B1, 32B2 of the door 32B are not connected to the air blowing paths 38A, 38B and the air blowing port 40.

By stopping the doors 32A, 32B as shown in FIG. 2C, the cartridges 36A, 36B respectively can be cut-off from the outside air, and the perfumes that are filled in the cartridges 36A, 36B being released uselessly can be prevented.

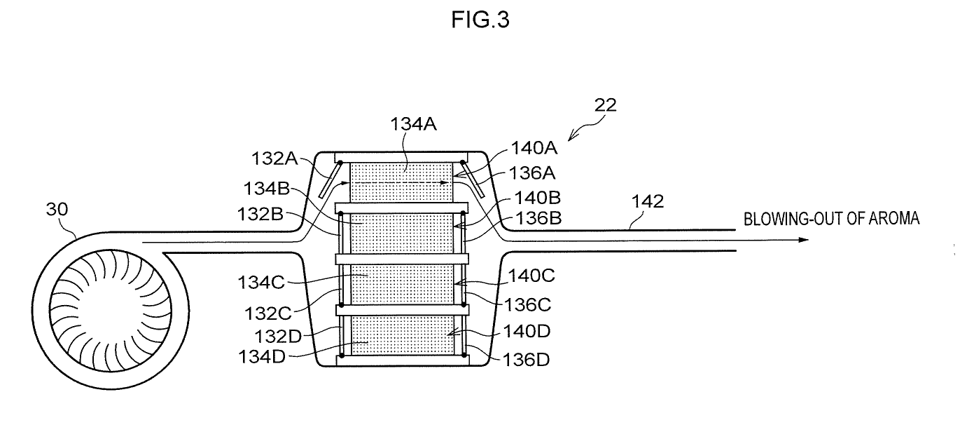

FIG. 3 is a schematic drawing showing another example of the aroma generating device 22 relating to the present exemplary embodiment. The aroma generating device 22 that is shown in FIG. 3 has cartridges in which respectively different perfumes are filled. The cartridges are a cartridge 134A, a cartridge 134B, a cartridge 134C and a cartridge 134D, and one cartridge to be used is selected. For example, the cartridge 134A is filled with a perfume that is minty and has a refreshing feeling, or the like, the cartridge 134B is filled with a perfume that is vanilla-based and gives a sweet and warm impression, or the like, the cartridge 134C is filled with a flowery essential oil based perfume that is derived from flowering plants, or the like, and the cartridge 134D is filled with a citrusy perfume.

The cartridges 134A, 134B, 134C, 134D are structures in which, for example, such perfumes are filled into carriers that are chemically inactive and that are porous and that are suitable for adsorbing the perfumes. For example, any of silica gel, alumina, diatomaceous earth, or the like is used as the carriers.

The cartridges 134A, 134B, 134C, 134D are respectively loaded into channels 140A, 140B, 140C, 140D that are paths of the blown air from the blower 30 that is structured by a multiblade fan, such as a sirocco fan or the like, that is rotated by an electric motor.

Valves 132A, 136A are provided at the channel 140A. Valves 132B, 136B are provided at the channel 140B. Valves 132C, 136C are provided at the channel 140C, and valves 132D, 136D are provided at the channel 140D. The valve 136A opens/closes in conjunction with the valve 132A, and carries out opening or closing of the channel 140A which is an air blowing path. Similarly, the valves 136B, 136C, 136D open/close in conjunction with the valves 132B, 132C, 132D, respectively, and carry out opening or closing of the channels 140B, 140C, 140D respectively. As an example, the respective valves 132A through 136D are opened/closed by electric actuators.

Respectively different perfumes are filled in the cartridges 134A, 134B, 134C, 134D. Therefore, the valves that are opened are any one group among the group of the valves 132A, 136A, the group of the valves 132B, 136B, the group of the valves 132C, 136C, and the group of the valves 132D, 136D. For example, when the group of the valves 132A, 136A is opened and the other valves are closed, the blown air from the blower 30 passes through the cartridge 134A, and the aromatic components of the perfume filled in the cartridge 134A are supplied into the vehicle cabin via a blower tube 142. Further, when the group of the valves 132B, 136B is opened and the other valves are closed, the aromatic components of the perfume filled in the cartridge 134B are supplied into the vehicle cabin via the blower tube 142. Moreover, when the group of the valves 132C, 136C is opened and the other valves are closed, the aromatic components of the perfume filled in the cartridge 134C are supplied into the vehicle cabin via the blower tube 142. Still further, when the group of the valves 132D, 136D is opened and the other valves are closed, the aromatic components of the perfume filled in the cartridge 134D are supplied into the vehicle cabin via the blower tube 142.

Further, in a case in which the releasing of the perfumes filled in the cartridges 134A, 134B, 134C 134D into the vehicle cabin is unnecessary, by closing all of the valves 132A through 136D, useless emission of the perfumes that are filled in the cartridges 134A, 134B, 134C, 134D is prevented.

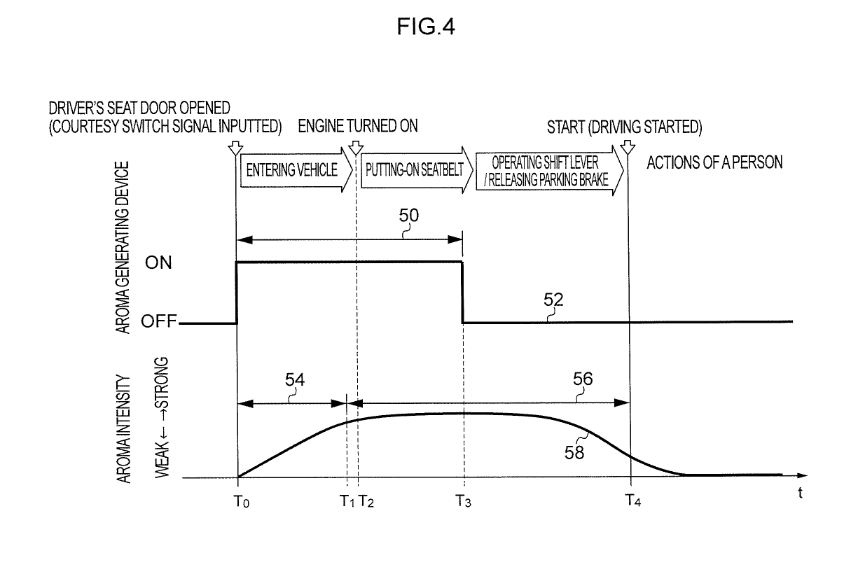

FIG. 4 is a timing chart showing an example of the state of operation over time of the aroma generating device 100 for a vehicle relating to the present exemplary embodiment. As shown in FIG. 4, at the aroma generating device 100 for a vehicle relating to the present exemplary embodiment, in a case in which the A/C-ECU 10 senses, at time T₀ and by an ON signal from the courtesy switch 2, that the driver's seat door has been opened, that ON signal is inputted from the A/C-ECU 10 to the aroma control device 20, and the aroma control device 20 turns the aroma generating device 22 ON. As shown by aroma generating device operation curve 52 in FIG. 4, the aroma control device 20 turns the aroma generating device 22 off at time T₃. At the aroma generating device 100 for a vehicle relating to the present exemplary embodiment, during predetermined time period 50 from the time T₀ that the driver's seat side door is opened until time T₃, the aroma generating device 22 is operated, and, after the predetermined time period 50 has elapsed, operation of the aroma generating device 22 is stopped.

The length of the predetermined time period 50 differs in accordance with the specifications of the aroma generating device 100 for a vehicle, the size of the vehicle cabin interior, and the like, but, as an example, is from around several seconds to around 20 seconds. One of the bases for the determination of the predetermined time period 50 is a first effective time period 54 that is the time until the vehicle occupant starts to smell the aroma. The first effective time period 54 is from the time T₀ when the door at the driver's seat side is opened until time T₁ when the sitting-down of the vehicle occupant is completed. If it is made such that the vehicle occupant smells the aroma at the time when he/she sits-down, the aroma generating device 22 can be effectively operated while conserving the amount of the aromatic components that are released from the aroma generating device 22.

In the present exemplary embodiment, the first effective time period 54 is the time period that is from the time T₀ until the time T₁ that is immediately before time T₂ when the engine of the vehicle is started-up. The period of time from the time T₀ to the time T₂ differs in accordance with the vehicle type and the vehicle model, but is generally around 5 to 10 seconds. In the present embodiment, in consideration of the time up until the time T₂, the first effective time period 54 is made to be approximately 5 seconds as an example.

The time T₃ at which the predetermined time period 50 ends is the time at which the intensity of the aroma that the vehicle occupant smells within the vehicle cabin (the aroma intensity) becomes an upper limit value. As shown by aroma intensity curve 58 in FIG. 4, the aroma intensity gradually becomes greater from time T₂ on, and, even when the aroma generating device 22 is being operated, plateaus in a vicinity of the time T₃, and the aroma intensity curve 58 becomes substantially rectilinear. In the present exemplary embodiment, the time when the aroma intensity within the vehicle cabin becomes the upper limit value is time T₃, and the aroma generating device 22 is turned OFF at this time T₃.

However, the change in the aroma intensity curve 58 in a vicinity of the time T₃ is gentle, and the peak is not distinct. Therefore, in the present exemplary embodiment, the time T₃ and the predetermined time period 50 are determined in consideration of a second effective time period 56 which is the time period over which the vehicle occupant can smell the aroma. By determining the time T₃ and the predetermined time period 50 in consideration of the second effective time period 56, the aromatic components can be dispersed effectively within the vehicle cabin without being released wastefully.

For example, the time T₃ and the predetermined time period 50 are set such that the second effective time period 56 continues until time T₄ which is the time until the seated vehicle occupant puts on the seatbelt, shifts the shift lever to the D position, releases the parking brake, and starts driving the vehicle.

Because the time T₃ and the predetermined time period 50 differ in accordance with the specifications of the aroma generating device 100 for a vehicle, the size of the vehicle cabin interior and the like, they are determined concretely through experimentation using a tester or the like.

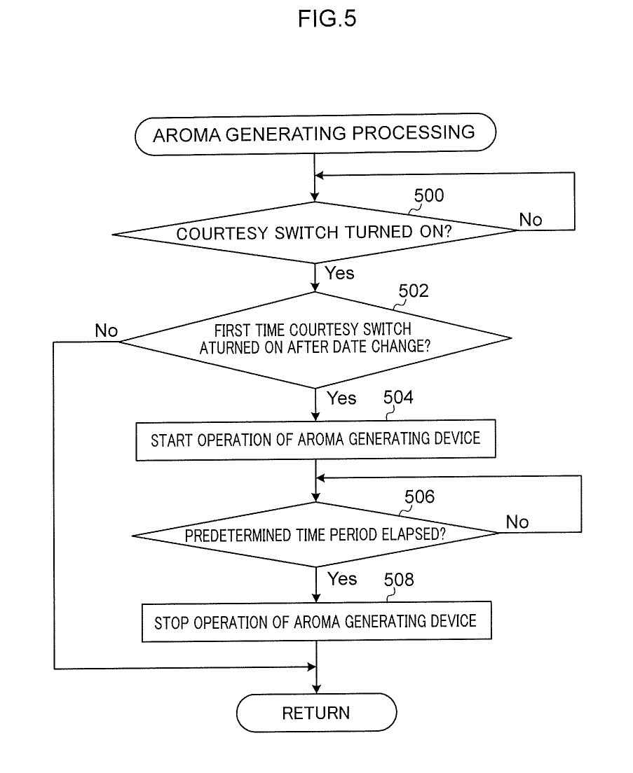

FIG. 5 is a flowchart showing an example of aroma generating processings of the aroma generating device 100 for a vehicle relating to the present exemplary embodiment. The processings of FIG. 5 are carried out, for example, in cooperation with the A/C-ECU 10 and the aroma control device 20. In step 500, it is determined whether or not the courtesy switch 2 has been turned ON.

In a case in which it is determined that the courtesy switch 2 has been turned ON in step 500, in step 502, it is determined whether or not the courtesy switch 2 has been turned ON for the first time after the date has changed. The reason for a determination that is based on after the date has changed is in order to make it such that driving after waking or the first drive of the day may be started pleasantly. The A/C-ECU 10 counts the number of times that the courtesy switch 2 has been turned ON after a change in the date, and resets this count to 0 after the date changes. When courtesy switch 2 is turned ON, in a case in which this count is 0, in step 502, the A/C-ECU 10 determines that this is the first time that the courtesy switch 2 has been turned ON after the date has changed.

Because the A/C-ECU 10 is a microcomputer, it can compute the time by the accumulation of clock signals. Accordingly, in the present exemplary embodiment, whether or not the date has changed is determined on the basis of the time counted by the A/C-ECU 10. Over a long period of time, errors between the time counted by the accumulation of clock signals and the actual time arise, and therefore, the time may be corrected by using signals from GPS (Global Positioning System) satellites or the like.

In step 502, in a case in which it is determined that the courtesy switch 2 has been turned ON for the first time after a change in the date, the process proceeds to step 504. In a case in which the above-described count is greater than or equal to 1 in step 502, it is determined that this is the second or greater time that the courtesy switch 2 has been turned ON after the change in date, and the process returns.

In step 504, operation of the aroma generating device is started. In step 506, it is determined whether or not the predetermined time period 50 has elapsed. In a case in which the predetermined time period 50 has elapsed, in step 508, operation of the aroma generating device 22 is stopped, and the process returns.

In a case in which it is determined in step 506 that the predetermined time period 50 has not elapsed, operation of the aroma generating device 22 is continued.

As described above, in the aroma generating device 100 for a vehicle relating to the present exemplary embodiment, by detecting that the courtesy switch 2 has been turned ON and by operating the aroma generating device 22 for the predetermined time period 50, control of the generation of an aroma which takes into consideration the timing at which a vehicle occupant enters into the vehicle. In the present exemplary embodiment, the aroma generating device 22 is operated on the basis of signals from the courtesy switch 2 of the driver's seat door. However, the aroma generating device 22 may be operated when the opening of the front passenger's seat door, or the opening of a rear seat door, is detected.

Note that, the door opening detecting section corresponds to the courtesy switch 2, the aroma generating section corresponds to the aroma generating device 22, and the aroma control section corresponds to the aroma control device 20.

What is claimed is:

1. An aroma generating device for a vehicle, comprising:
a door opening detecting section configured to detect whether or not a door of a vehicle has been opened;
an aroma generating section configured to release aromatic components within a vehicle cabin at a time of operation, the aromatic components are filled within a container; and
an aroma control section configured to control the aroma generating section to start operation in a case in which the door opening detecting section detects that a door has been opened, and to stop operation in a case in which a predetermined time period has elapsed from the start of operation of the aroma generating section.

2. The aroma generating device for a vehicle of claim 1, wherein the aroma control section is configured to control the start of the operation of the aroma generating section in a case in which the door opening detecting section detects that a door has been opened a first time after a change in date.

3. The aroma generating device for a vehicle of claim 1, wherein the predetermined time period is from the start of operation of the aroma generating section until an intensity of aromatic components that a vehicle occupant smells within the vehicle cabin becomes an upper limit value.

4. The aroma generating device for a vehicle of claim 1, wherein the door opening detecting section detects whether or not a driver's seat door has been opened.
